(19) United States
(12) Patent Application Publication
(10) Pub. No.: US 2026/0058870 A1
(43) Pub. Date: Feb. 26, 2026

(54) Method and System for Adaptive Network Management with Advanced Wake-Up Mechanisms

(71) Applicant: XinXin Shan, Surrey (CA)

(72) Inventor: XinXin Shan, Surrey (CA)

(73) Assignee: LED Smart Inc., Surrey (CA)

(21) Appl. No.: 18/815,599

(22) Filed: Aug. 26, 2024

(51) Int. Cl. H04L 41/0833; H04L 9/40; H04L 41/16; H04L 67/12

(52) U.S. Cl. CPC H04L 41/0833; H04L 41/16; H04L 63/12; H04L 67/12

(57) ABSTRACT

This invention provides an adaptive network management system for mesh networks, utilizing advanced wake-up mechanisms that include AI-driven predictive algorithms, adaptive transmission protocols, multi-layer verification processes, and device-specific wake-up profiles. The system is designed to improve network efficiency, reduce latency, and enhance energy management by selectively waking up devices based on real-time conditions, predefined schedules, or a combination of both. This system is applicable to a variety of fields, including military communications, industrial automation, and smart grids, where reliable and efficient network management is critical.

### CROSS-REFERENCE TO RELATED APPLICATIONS

US PATENT DOCUMENTS

U.S. Pat. No. 10,396,590 B2 August 2019 Teggatz

U.S. Pat. No. 7,542,421 B2 June 2009 Srikrishna

U.S. Pat. No. 9,450,823 B2 September 2016 Arora

### Other Publication

Musilek P. et al, “Review of nature-inspired methods for wake-up scheduling in wireless sensor networks”, Swarm and Evolutionary Computation, Volume 25, December 2015, Pages 100-118

Bardoutsos A. et al, “Energy Efficient Algorithm for Multihop BLE Networks on Resource-Constrained Devices”, 2019 15th International Conference on Distributed Computing in Sensor Systems (DCOSS), Santorini, Greece, 2019, pp. 400-407, doi: 10.1109/DCOSS.2019.00083.

Bica I. et al, “Multi-Layer IoT Security Framework for Ambient Intelligence Environments”, Sensors 2019, 19, 4038. https: //doi. org/10.3390/s19184038

Harsha S. “Towards Green Wifi Networks: An ML And AI-Based Framework For Energy Efficiency Optimization”, International Journal of Civil Engineering and Technology (IJCIET), Volume 15, Issue 3, May-June 2024, pp. 11-20, Article ID: IJCIET_15_03_002

### BACKGROUND OF THE INVENTION

Mesh networks are widely used in various applications, from industrial control systems to military communications, due to their robustness and scalability. However, these networks face significant challenges, including communication congestion, inefficient energy consumption, and the complexity of managing devices with varying roles and priorities.

Traditional wake-up systems in mesh networks often rely on pre-determined schedules or manual activation protocols, which can result in unnecessary device activations, network congestion, and excessive power consumption. These limitations are exacerbated in dynamic environments where network conditions and device roles are constantly changing.

To address these challenges, the present invention introduces a method and system for adaptive network management using advanced wake-up mechanisms. These mechanisms incorporate AI-driven predictive algorithms, adaptive transmission protocols, multi-layer signal verification, and device-specific wake-up profiles to optimize the wake-up process, improve network efficiency, and ensure reliable communication.

### SUMMARY OF THE INVENTION

The present invention provides a method and system for adaptive network management in mesh networks, focusing on optimizing the wake-up process of network devices. The system is designed to work under various conditions, either with AI-driven or non-AI-based methodologies, or a combination of both, ensuring flexibility and robustness in network management.

The invention comprises three key methods: an AI-driven approach, a non-AI-based approach, and a hybrid approach combining both AI and non-AI methodologies. Each method incorporates advanced features such as predictive algorithms, adaptive transmission protocols, and multi-layer verification processes to ensure efficient and reliable network operations.

### BRIEF DESCRIPTION OF DRAWINGS

FIG. 1: Flowchart for AI-Driven Wake-Up System

FIG. 2: Flowchart for Non-AI-Based Wake-Up System

FIG. 3: Flowchart for Hybrid AI-Driven and Non-AI-Based Wake-Up System

FIG. 4: Flowchart for Device-Specific Wake-Up Profiles Management

FIG. 5: Flowchart for Multi-Layer Signal Verification Process

### DETAILED DESCRIPTION OF THE INVENTION

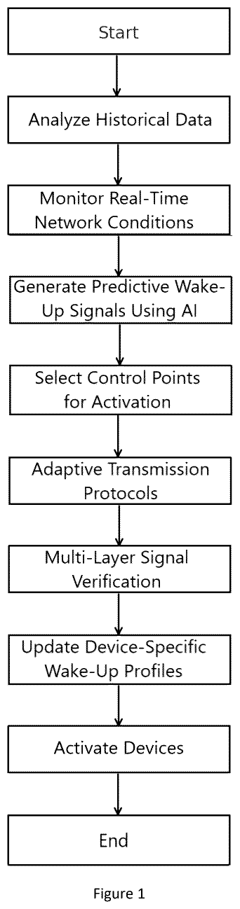

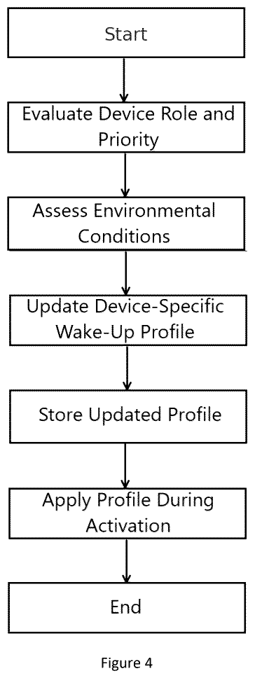

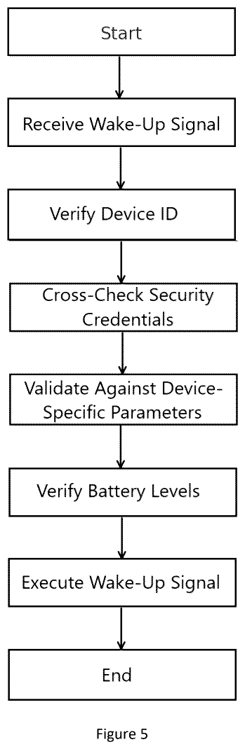

A method for adaptive network management in a mesh network using an AI-driven approach, comprising generating wake-up signals using AI algorithms that analyze historical data, real-time network conditions, and forecasted energy consumption patterns to selectively activate control points within the network (see FIG. 1). These signals ensure that only necessary devices are activated, optimizing energy efficiency and reducing network latency. The method further includes utilizing adaptive transmission protocols that modify the power and method of signal transmission based on current network congestion levels, interference, and device criticality (see FIG. 1). This adaptability enhances the robustness and reliability of network communications. Additionally, the method implements a dual-state mode management system that transitions control points between active, sleep, and partial sleep states (see FIG. 1). These transitions are optimized through AI predictions of network activity and energy models, further enhancing energy efficiency. The method also employs a multi-layer verification process to validate wake-up signals across multiple parameters, such as battery levels, task priorities, and security credentials, before device activation (see FIG. 5). This process ensures secure and accurate device wake-up. Finally, the method ensures that each device has a dynamically updated wake-up profile, dictating how and when it should be woken up based on its role, priority, and environmental conditions (see FIG. 4). This fine-tuning maximizes network efficiency and responsiveness.

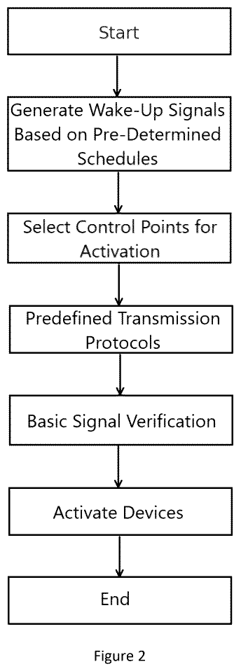

A method for adaptive network management in a mesh network using a non-AI-based approach, comprising generating wake-up signals based on pre-determined schedules and manual activation protocols. These signals target specific control points within the network, identified by unique IDs, ensuring predictable network operations (see FIG. 2). The method further includes utilizing predefined transmission protocols optimized for consistent network conditions, with the capability to switch protocols if necessary, maintaining reliable communication (see FIG. 2). Additionally, the method implements a non-AI-based dual-state mode management system that transitions control points between active, sleep, and partial sleep states, based on predefined energy models and operational protocols (see FIG. 2). The method also applies a basic verification process to ensure that wake-up signals are executed only when predefined conditions are met, preventing unnecessary activations (see FIG. 5). Finally, the method ensures that each device follows a fixed wake-up profile designed during the initial setup, providing a straightforward and reliable wake-up process (see FIG. 4).

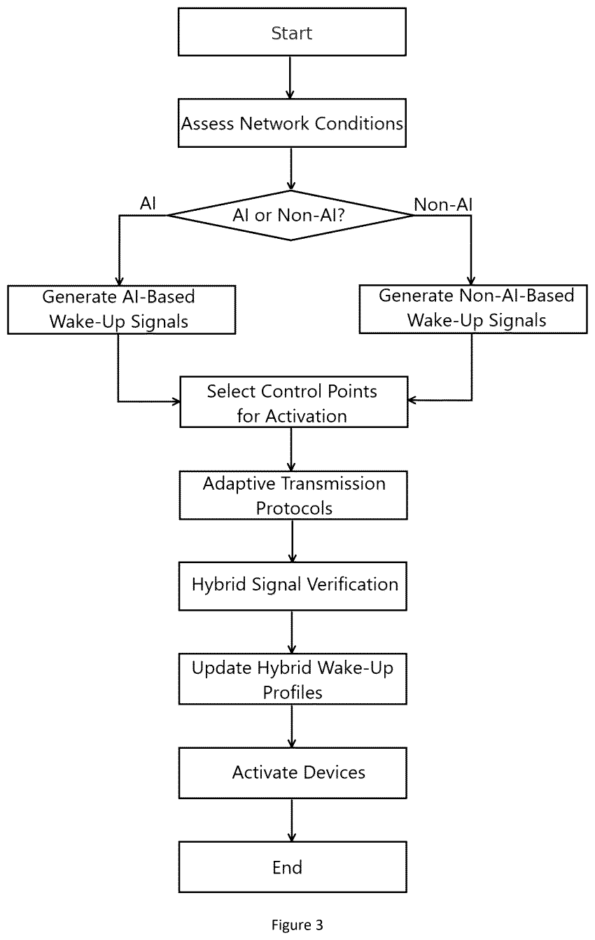

A method for adaptive network management in a mesh network using a hybrid AI-driven and non-AI-based approach, comprising switching between AI-enhanced and non-AI methods to maintain optimal network performance under varying conditions. Each control point is targeted precisely using its unique ID (see FIG. 3). The method further includes generating wake-up signals using either AI-based predictions or pre-determined schedules, depending on network conditions. These signals are directed to the appropriate control point based on its unique ID (see FIG. 3). Additionally, the method involves dynamically forming and adjusting network topology using AI-driven analysis or predefined protocols, as appropriate, enhancing network adaptability (see FIG. 3). The method also implements dual-state mode management that allows control points to transition between active, sleep, and partial sleep states, with transitions determined by both AI and non-AI methods (see FIG. 3). Furthermore, the method employs a hybrid verification system that incorporates both AI-based and predefined checks to validate wake-up signals before activation, ensuring secure and efficient network operations (see FIG. 5). Finally, the method ensures that each device follows a hybrid wake-up profile that combines AI-driven updates with non-AI fixed schedules, optimizing the wake-up process under varying conditions (see FIG. 4).

1. A method for adaptive network management in a mesh network using an AI-driven approach, comprising:
Generating advanced predictive wake-up signals using AI algorithms that analyze historical data, real-time network conditions, and forecasted energy consumption patterns to selectively activate at least one control point within the network, each identified by a unique ID;
Utilizing adaptive transmission protocols that modify the power and method of signal transmission based on current network congestion levels, interference, and device criticality;
Implementing AI-enhanced dual-state mode management to transition control points between active, sleep, and partial sleep states, optimized through AI predictions of network activity and energy models;
Employing a multi-layer signal verification process to ensure that wake-up signals are validated across multiple parameters before device activation;
Ensuring device-specific wake-up profiles, where each device in the network has a dynamically updated profile dictating how and when it should be woken up, based on the device's role, priority, and environmental conditions.

2. The method of claim 1, wherein the AI algorithms further incorporate machine learning techniques to continuously improve the accuracy of predictive wake-up signals based on newly acquired data.

3. The method of claim 1, wherein the adaptive transmission protocols include options for low-power communication in densely populated network areas to reduce interference and energy consumption.

4. The method of claim 1, wherein the multi-layer signal verification process includes the use of cryptographic techniques to ensure the authenticity of the wake-up signals, preventing unauthorized device activations.

5. The method of claim 1, wherein the system is implemented in a military communication network to optimize the deployment and management of tactical devices in the field.

6. The method of claim 1, further comprising a feedback mechanism that adjusts the AI algorithms based on the success rate of wake-up signals, enhancing the system's adaptive capabilities over time.

7. A method for adaptive network management in a mesh network using a non-AI-based approach, comprising:
Generating wake-up signals based on pre-determined schedules and manual activation protocols, targeting at least one specific control point within the network, each identified by a unique ID;
Utilizing predefined transmission protocols optimized for consistent network conditions, with the ability to switch protocols if required;
Implementing a non-AI-based dual-state mode management system that transitions control points between active, sleep, and partial sleep states, according to predefined energy models and operational protocols;
Applying a basic verification process to ensure that wake-up signals are executed only when predefined conditions are met;
Ensuring that each device follows a fixed wake-up profile designed during the initial setup, providing a straightforward and reliable wake-up process.

8. The method of claim 7, wherein the predefined transmission protocols include a fallback mechanism to ensure communication reliability in the event of network disturbances.

9. The method of claim 7, wherein the fixed wake-up profiles are designed to account for device-specific battery life considerations, ensuring that devices with lower battery levels are woken up less frequently.

10. The method of claim 7, wherein the system is utilized in industrial automation to manage the wake-up process of sensors and control devices based on predefined operational schedules.

11. The method of claim 7, further comprising a manual override feature that allows network operators to initiate wake-up signals outside of the predefined schedule in case of emergencies or unforeseen events.

12. A method for adaptive network management in a mesh network using a hybrid AI-driven and non-AI-based approach, comprising:
Seamlessly switching between AI-enhanced and non-AI methods to maintain optimal network performance under varying conditions, with each control point having a unique ID for precise targeting;
Generating wake-up signals using either AI-based predictions or pre-determined schedules, depending on network conditions, and directing these signals to the appropriate control point based on its unique ID;
Dynamically forming and adjusting network topology using AI-driven analysis or predefined protocols as appropriate;
Implementing dual-state mode management that allows control points to transition between active, sleep, and partial sleep states, with transitions determined by both AI and non-AI methods;
Employing a hybrid verification system that incorporates both AI-based and predefined checks to validate wake-up signals before activation;
Ensuring that each device follows a hybrid wake-up profile that combines both AI-driven updates and non-AI fixed schedules, optimizing the wake-up process under varying conditions.

13. The method of claim 12, wherein the hybrid verification system includes a multi-stage process that combines AI-based predictions with manual overrides to ensure critical devices are activated when necessary.

14. The method of claim 12, wherein the hybrid wake-up profiles are periodically updated based on a combination of AI-driven analysis and operator input to reflect changing network conditions and operational priorities.

15. The method of claim 12, wherein the system is applied in a smart grid network to manage the wake-up process of distributed energy resources based on both real-time grid conditions and scheduled maintenance operations.

16. The method of claim 12, further comprising a monitoring system that tracks the performance of both AI-driven and non-AI-based wake-up processes, providing operators with insights for further optimization.
